(19) United States
(12) Patent Application Publication
(10) Pub. No.: US 2018/0262278 A1
(43) Pub. Date: Sep. 13, 2018

(54) TRANSMISSION OF INFORMATION BY ACOUSTIC COMMUNICATION ALONG METAL PATHWAYS IN NUCLEAR FACILITIES

(71) Applicant: UChicago Argonne, LLC, Chicago, IL (US)

(72) Inventors: Alexander Heifetz, Riverwoods, IL (US); Richard B. Vilim, Sugar Grove, IL (US); Sasan Bakhtiari, Darien, IL (US)

(21) Appl. No.: 15/947,303

(22) Filed: Apr. 6, 2018

Related U.S. Application Data
(60) Provisional application No. 62/461,137, filed on Feb. 20, 2017.

(51) Int. Cl. H04B 11/00; H04B 7/155; G08C 23/02

(52) U.S. Cl. CPC H04B 11/00; H04W 4/38; G08C 23/02; H04B 7/15528

(57) ABSTRACT

The invention provides a system for transmitting a signal. The signal uses at least one metallic transmission medium to which at least a pair of transducers is attached. Each transducer contains an interface and connection to an external signal capable of sending and receiving a signal. Each transducer converts the external signal to an ultrasonic version to be sent over the medium and also converts a received ultrasonic version back to an external signal.

### PRIORITY CLAIM

The instant application claims priority as a non-provisional of provisional application 62/461,137, with a filing date of Feb. 20, 2017, the contents of which are incorporated herein by reference.

### CONTRACTUAL ORIGIN OF THE INVENTION

The U.S. Government has rights in this invention pursuant to Contract No. DE-AC02-06CH11357 between the U.S. Department of Energy and UChicago Argonne, LLC, representing Argonne National Laboratory.

### BACKGROUND OF THE INVENTION

### 1. Field of the Invention

This invention relates to a device and method for transmission of information employing acoustic signals wherein the signals are propagated as guided elastic waves in existing infrastructure, such as pipes. The system includes components to modulate and demodulate digital signals into an analog signal which is transmitted using guided elastic waves using at least a pair of transducers.

### 2. Background of the Invention

Several sensitive industrial and research processes require shielding barriers. The composition and thickness of such vessels impedes communication with equipment found within the shield barriers, including sensors and electromechanical controllers, even when such devices are critical to the process occurring within the barrier.

An example of this difficulty is the containment building of a nuclear reactor. Such containment buildings will feature walls having a thickness of several feet of reinforced concrete. Further, the concrete is frequently reinforced with steel metal liner plates. Maintaining communication with the interior of such a structure is difficult from the outside, as typical high-throughput wireless radio-frequency (RF) signals will simply not penetrate the exterior wall. However, maintaining communications with sensors within the structure is critical, especially during a period of disrupted operations.

One potential solution is to use RF wireless communications of various frequencies and power to penetrate the enclosure. For example, transmissions in the VHF band of 30 MHz to 300 MHz will have fewer problems in penetrating the concrete and steel structure than the typical microwave frequencies of 900 MHz, 2.4 GHz used for communications. However, the required power would limit antenna choices (resulting in a bulky antenna), and the reach of such signals would be difficult to limit. For instance, a signal powerful enough to penetrate the structure would not attenuate for several hundred meters, and could be received even a mile away. As such, using wireless communications would pose security and other challenges, including interference with other VHF broadcasts. Presence of metallic liner plate in a barrier would eliminate the possibility of through-barrier wireless RF communications altogether.

A typical response may be to employ a wired communications channel, such as a coaxial or fiber optic cable. This approach may be suitable for new construction of such secure facilities; however in many cases it is not feasible for existing structures. To install such a communications link would require the breaching of an enclosure wall. As many of these structures are designed to withstand interior pressures of two to six atmospheres, the drilling of an aperture would create a weak point for releasing pressurized contents. Further, strict regulatory requirements prohibit drilling into containment building walls of a nuclear facility.

Nonetheless, even the oldest of such containment buildings will have pre-existing connections to the exterior in the form of pipe connections. In one embodiment, the system uses these existing connections to send and receive a signal with the interior of the secure enclosure. The system is resilient and continues to send and receive information even without external power.

A need exists in the art for a system to employ existing metallic conduits to exchange information with the interior of the secure building that is not susceptible to high-temperatures and high radiation levels.

### SUMMARY OF INVENTION

An object of the invention is to provide a device and method of communicating using existing infrastructure that overcomes many of the disadvantages of the prior art.

Another object of the present invention is to provide a method of transmitting information to the interior of a shielded structure. A feature of the method is the use of several transducers attached to existing pipes to facilitate transmission of signals to protected areas. An advantage of the method is that communications with the interior of a protected structure can be maintained without breaching the physical barrier of the shielded structure.

Yet another object of the invention is to provide a device which can be retrofitted to any kind of pipe system. A feature of the use of electromagnetic acoustic transducers (EMAT) to generate a broadband signal which is transmitted via the metallic pipe. An advantage of the invention is that a copulant is not required and the transducers may be installed on any type of pipe.

Still another object of the invention is to provide a standby system for communication with a shielded secure building. A feature of the invention is the use of transceivers which can be installed at any time and may be kept idle for extended durations of time. An advantage of the invention is the components of the system do not require consumables and the components do not require power to remain attached to the building components whereby the operation of the transducers is not adversely affected by periods of idleness.

Yet another object of the invention is to provide a system which can operate regardless of the ambient temperature or other status of the pipes being used for the transmission media in the system. A feature of the invention is the transducers are securely attached and are not sensitive to temperature or fluid flow within the pipe being used to convey the signal. An advantage of the invention is that the system will operate even if the fluid in the pipes being used to convey the system changes in pressure or volume or flow rate.

Still another object of the invention is to provide a system which can operate on ferromagnetic and non-ferromagnetic pipes. A feature of the invention is the use of an adjustable current transducer whose voltage is changed in response to the propagation properties of the installation site. An advantage of the invention is that the system can be used to retrofit a large variety of secure buildings, including ones that use stainless steel piping and ones that rely on other types of pipes.

Briefly, the invention provides a system for transmitting a signal, the system comprising: at least one metallic transmission medium having a proximal end and a distal end; and at least a pair of transducers wherein one transducer is located at the proximal end of the transmission medium and a corresponding transducer is located at the distal end; wherein each transducer contains an interface and connection to an external signal connection capable of sending and receiving a signal; wherein each transducer converts an external signal received by its interface to an ultrasonic signal and transmits the ultrasonic version of the external signal over the metallic transmission medium; and wherein each transducer receives the ultrasonic version of the external signal over the metallic transmission medium and converts the ultrasonic version of the external signal and sends the signal to its interface.

### BRIEF DESCRIPTION OF DRAWINGS

The patent application file contains at least one drawing executed in color. Copies of this patent or patent application publication with color drawing(s) will be provided by the Office upon request and payment of the necessary fee.

The invention together with the above and other objects and advantages will be best understood from the following detailed description of the preferred embodiment of the invention shown in the accompanying drawings, wherein:

FIG. 1 depicts an cut away view of a secure building that can be used in conjunction with an embodiment of the present invention;

FIG. 2 is a cut away view of a metallic medium being used in conjunction with one embodiment of the present invention;

FIG. 3 is a schematic view of an embodiment of the system in accordance with the features of the present invention;

FIG. 4 is a detailed view of several transmission components used in an embodiment of the present invention;

FIGS. 5A and 5B depict two further embodiments of components used in the system;

FIG. 6 is a view of one embodiment of the system; and

FIG. 7 is a plot of signal as received by an embodiment of the system.

### DETAILED DESCRIPTION OF THE INVENTION

The foregoing summary, as well as the following detailed description of certain embodiments of the present invention, will be better understood when read in conjunction with the appended drawings.

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

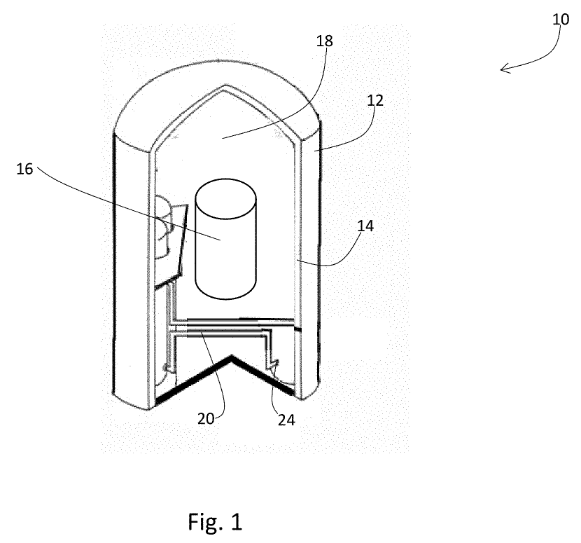

Turning to FIG. 1, depicted therein is a cutaway view of a secure building 12 having an exterior wall 14. The secure building is located in an exterior environment 10. The secure building 12 is used to house a process 16. In one embodiment, the process 16 is a chemical reaction. In another embodiment, the process 16 is a nuclear reactor.

The building exterior wall 14 comprises a reinforced concrete material of a thickness of at least 3 feet. In an embodiment used in conjunction with a nuclear reaction, the exterior wall 14 further comprises reinforcement using lead and other metals, designed to protect the environment from radiation. The exterior walls 14 also protect the process 16 from incursions from the exterior environment, such as a projectile striking the secure building 12.

In one embodiment, not shown, the exterior wall comprises two thick walls separated by a space. In some embodiments, this space is sufficiently large to act as a walkway, resulting in a secure building having double exterior walls.

While the secure building includes one or more exterior walls 14, the building 12 is not completely isolated from the exterior environment. The building 12 includes at least one pipe 20 connection wherein the pipe connection passes through the building 12 interior 18 and also passes through the wall 14 to an exterior space. This pipe 20 is used to support a process 16 which is not self-contained (as most processes 16 require external inputs and/or result in outputs to be sent externally). In FIG. 1, the pipe 20 passes through the external wall 14 at point 24.

Due to the composition of the exterior wall 14, any radio signal which attempts to pass through the exterior wall 14 (in either direction) will be highly degraded. The power level of a signal which reliably transmits information through the wall 14 would be extremely high and so this signal would not only penetrate the exterior wall 14 but would also be subject to eavesdropping outside of the secure facility. The power of the signal may be adjusted depending on the frequency used, with better propagation seen at lower frequencies (such as VHF or HF radio transmissions). However, to achieve reliable transmission, impracticable power and antenna configurations would have to be deployed to the interior 18 of the secure building 12. Most of the secure buildings 12 do not have a large amount of space to store additional equipment within the interior area 18.

Instead of attempting to penetrate the exterior wall 14 with a high power signal, the instant system uses a pipe 20 already built into the structure 12. The pipe 20 is already in communication with the outside environment 10 and its end 24 already passes through the exterior wall 14.

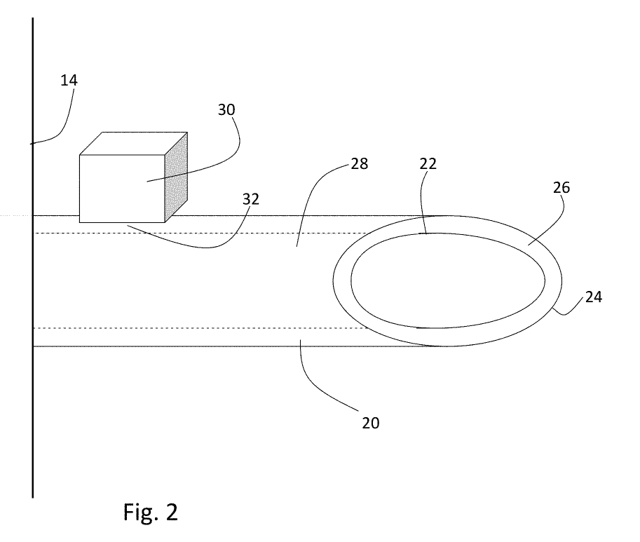

Turning to FIG. 2, depicted therein is a partial view of a pipe 20 pursuant to an embodiment of the invention. The pipe 20 has an interior wall 22 and exterior wall 24. The interior wall 22 forms a channel for transmission of a fluid, gas, solid matter, or any other material, including maintaining a vacuum or near vacuum. Further, the system continues to operate while the pipe 20 is filled or is empty.

The main body 26 of the pipe 20 comprises a metallic substrate between the interior wall 22 and the exterior wall 24. The pipe 20 includes an end 28, with one end 28 located within a secure structure 12 and a second end 38 located outside the secure structure 12. While the pipe 20 is shown as being open to the environment in FIG. 2, the pipe is closed off in other embodiments. Further, the pipe 20 may continue beyond the end 28.

As shown in FIG. 2, the transmitting device 30 is located at a position 32 in between the end 28 of the pipe and the external wall 14 of the secure building. The connection between the pipe 20 and the device 30 is discussed below.

### Transmitting Device Detail

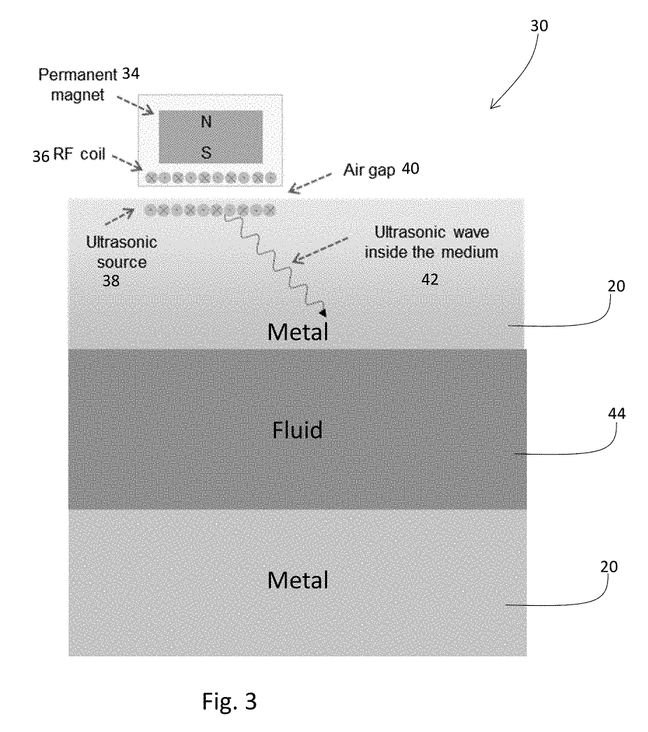

A schematic overview of one embodiment of the transmitting device 30 is depicted in FIG. 3, which shows a cross section of a pipe filled with fluid with the system installed thereon.

The transmitting device 30 is placed in proximity to a metallic pipe 20. The interior of the pipe 20 carries a fluid 44 in the embodiment shown in FIG. 3. However, the transmitting device 30 operates independently of the contents of the pipe 20. While in FIG. 3, the fluid 44 is depicted as occupying approximately the same amount of space as the thickness of the pipe 20, in other embodiments, the pipe 20 will be thinner than the width of the fluid. In one embodiment, the top and bottom pipe 20 cross sections comprise 10% of the cross section area, while the fluid 44 occupies the remaining 90%.

The transmitting device 30 comprises a permanent magnet 34 in electric communication with a magnetic side RF coil 36. Below the magnetic side RF coil 36 is the medium-side RF coil 38. An air gap 40 separates the magnetic side RF coil 36 and the medium-side RF coil 38. In one embodiment, the air gap 40 is measured several millimeters.

The permanent magnet 34 produces a first magnetic field (not shown). The medium-side RF coil 38 is driven by an alternating current power source. As the device 30 is transmitting an ultrasonic signal 42, the medium-side RF coil power source operates in the ultrasonic frequencies. As the current passes through the medium-side RF coil 38, it generates a second magnetic field.

A signal to be transmitted passes through the magnetic side RF coil 36. It likewise induces a magnetic field around the magnetic side RF coil 36, the third magnetic field in the system. Absent the third magnetic field, the first magnetic field is constant and the second magnetic field varies predictably according to the alternating current power source. However, when the third magnetic field is induced by changes in the magnetic-side RF coil 36, the third magnetic field induces a change in the second magnetic field, which in turn changes the ultrasonic wave propagated within the medium, such as the pipe 20.

In one embodiment, the medium-side RF coil 38 is driven by AC power source of providing on the order of tens of Volts. The magnetic side RF coil 36 changes current over time in the range of 0 to 100 mA.

In this way the transmission device 30 functions as an electromagnetic acoustic transducer (EMAT).

As an EMAT, the transmission device 30 does not require a crystal and couplant, as would be the case of a piezoelectric transducer (PZT). Additionally, the embodiment shown in FIG. 3 uses a non-powered permanent magnet 34, avoiding the need for an additional power source. This allows the transmission device 30 to be installed on high-temperature pipes 20 and other metallic transmission media that are damaging to the PZT crystal. Typically, PZT's cannot be used on media whose temperature exceeds approximately 100 degrees Celsius.

Further, the transmission device 30 does not make contact with the transmission medium 20. For example, the transmission device 30 may be installed on a pipe carrying super-heated water or steam from a nuclear reactor. The air gap will insulate the transmission device 30 from the harshness of the environment.

Additionally, the transmission device 30 does not require a perfectly smooth surface to transmit the signal. The transmission device 30 can be installed on surfaces having been previously painted or welded.

The contents of the pipe 20 is not a factor in the transmission of the signal 42. The only requirement is that the pipe 20 be continuous and not be severed between the two transmission devices 30.

While in FIG. 3 the transmission device 30 is sending an ultrasonic signal, the process can readily be reversed to receive an ultrasonic signal from the medium 20. In one embodiment, each transmitter device 30 checks to ensure that the medium 20 is free to transmit prior to transmitting a signal. If an ultrasonic signal is already present, the transmission device 30 holds off transmitting and instead receives the signal. In other embodiments, the transmission devices 30 employ a medium sharing system such as Code Division Multiple Access to facilitate multiple device access to the same medium.

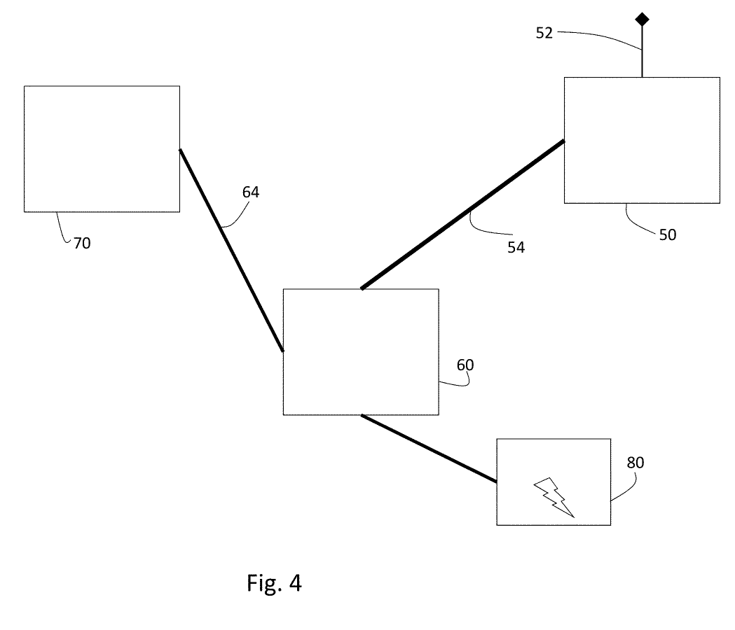

A schematic overview of the transmission device 30 is presented in FIG. 4.

The transmission device 30 comprises an external signal processing module 50. The external signal module 50 shown in FIG. 4 includes a reception antenna 52. As such, the external signal module 50 is designed to process an RF-signal, such as a microwave signal. In another embodiment, the external signal module 50 comprises an interface to a wired network, such as twisted pair copper wire. The external signal module 50 performs basic error checking and correction, in one embodiment.

A link 54 exists between the external signal module 50 and the signal processing module 60. The signal as received and verified by the signal processing module is passed over the link 54 to the signal processing module.

The signal processing module 60 converts the external signal to one that can be transmitted to the magnetic-side RF coil 36. In one embodiment, the processing module 60 will perform modulation of a received RF digital signal to an analog signal which is sent using ultrasonic frequencies. In another embodiment, the external signal is converted to a carrier wave which is not in the ultrasonic frequencies, but will result in changes in the ultrasonic frequencies when the three magnetic fields interact.

The processing module 60 detects properties of the transmission medium, in one embodiment. Multiple different encoding or carrier wave generation techniques may be used, but only some are suitable to the particular medium where the transmission device 30 is installed. Given the limited frequencies available for transmission (the ultrasonic frequencies), the options for signal encoding are likewise limited. Nonetheless, the detected properties of the medium, such as number of welds and the length of pipe to be traversed, will determine the encoding methodology used, in one embodiment.

Once the processing module 60 completes readies the signal to be sent to the magnetic side RF coil 36, the signal is sent via the second link 62 to the transmission module 70. In one embodiment, the transmission module 70 further amplifies the signal and ensures that the three magnetic fields are interacting as expected.

The device 30 includes a power source 80, depicted as powering the module 60. However, as all modules are in electric communication, power readily flows from one module to another.

In one embodiment the power source 80 is a battery. In another embodiment, the power source is an induction coil which in turn powers a battery. In this embodiment, the induction coil first harvests a signal being transmitted over a medium to power a battery and once the battery has reached sufficient power level, the remaining modules are powered. In some embodiments, the intermediate battery is eliminated and the induction coil powers the device 30 directly.

The power requirements of the transmission device 30 are measured in kW. At this power level the device can send an ultrasonic signal up to several hundred feet of standard pipe, with the maximum distance for recovering information from the received signal being dictated in part by the mode of excitation. For path lengths in the order of several feet (e.g., <10 ft. for piping going through containment structure) the transmission power requirements are below 10 W (10V at <1 A). The voltage used by the transducers (such as, ±10V at <5 A, in one embodiment) is adjusted depending on the type of medium used for the ultrasonic signal. A higher current is used for non-ferric materials such as stainless steel. Low voltages are used in embodiments using ferromagnetic pipes.

The composition and layout of the piping system determines the power use. In one embodiment, a transmission device will increase power of the ultrasonic signal until it receives an acknowledgement signal from a second device.

In one embodiment, the transmission devices can achieve a bandwidth of 100 KBps to 1 MBps. A pair of transmitters can transmit sensor data, such as radiation, pressure, and temperature, using low power. Using a high-speed transmission mode, the pair of devices 30 can be used to send video and sound as well as sensor data.

While the discussion of FIG. 4 above related to the process of transmitting a signal, the same device can be used to receive an ultrasonic signal. The process of receiving a signal will require the processing module 60 to perform more tasks, such as resolving noise in the received ultrasonic signal or separating an encoded signal in a CDMA scheme. If multiple transmission devices 30 are using a shared medium at the same time, or if the signal is bouncing and interfering with itself within a medium.

In one embodiment, pairs of transmission devices 30 are installed at each location on a pipe with a first transmission device 30 acting as a sender and the second transmission device 30 acting as a recipient. This ensures that the link is duplex, but also requires a medium sharing strategy to be deployed. In one embodiment, the processing module 60 is able to reconstruct a received signal even if 95% of the signal overlaps with another one, using echo removal techniques.

### EMAT Configurations

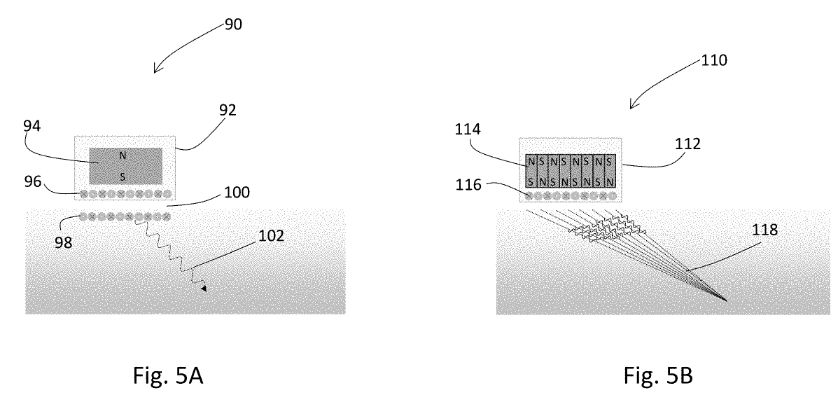

Turning to FIGS. 5A and 5B depicted therein are two configurations of EMATs, as are used as the transmittal device in the system in various embodiments. The permanent magnet embodiment 90 shown in FIG. 5A uses an enclosure 92 housing a permanent magnet 94 and the magnet side RF coil 96. The magnet side RF coil 96 is separated from the ultrasonic source 98 by an air gap 100. The ultrasonic source 98 generates an ultrasonic wave inside the transmission medium 102. The permanent magnet embodiment 90 was shown as installed in FIG. 3 and was discussed above.

A multiple magnet embodiment 110 is shown in FIG. 5B. In this multiple magnet embodiment 110, the transmission device comprises an enclosure 112 having multiple periodic permanent magnets 114, coupled to a single RF coil 116. Multiple ultrasonic waves 118 are generated and propagated through the transmission medium.

In this multiple magnet embodiment 110, ultrasonic waves having different properties may be generated simultaneously, or nearly simultaneously.

### Transmission Over a Pipe

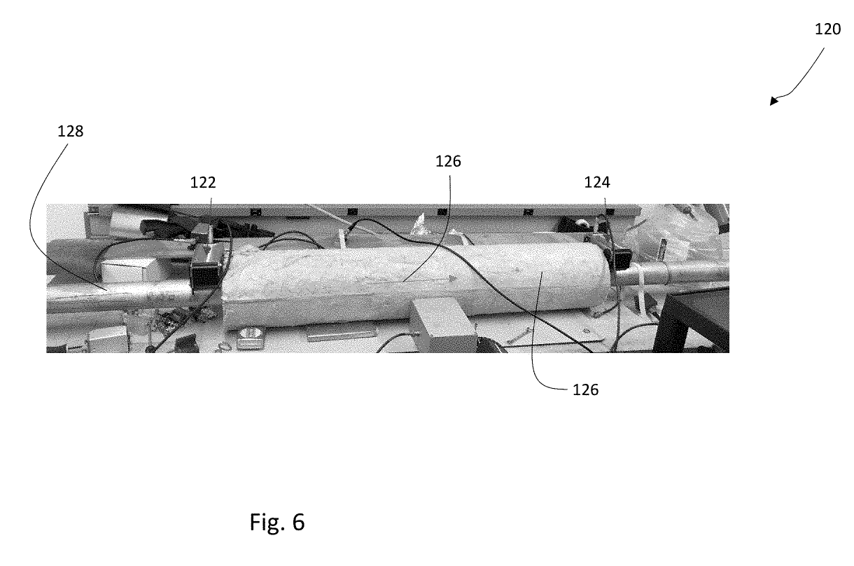

In the embodiment 120 shown in FIG. 6, the system comprises a source or transmitter EMAT 122 and a receiver EMAT 124. The source EMAT 122 transmits a lamb wave signal 126 (with the direction shown) over the pipe 128 with a thermal insulation layer 130. Lamb waves 126 are chosen as they propagate in solid plates.

The pipe 128 comprises a stainless-steel schedule-160 pipe. The pipe 128 dimensions are 2.375 inches outer diameter and 0.344 inch wall thick1ness. This variety of pipe is commonly found in chemical and volume control systems and heat exchanger charging lines. Such connections penetrate containment buildings.

The insulation 130 comprises a 2 inch thick layer of mineral wool thermal insulation, which again is commonly found in installations.

In the embodiment shown in FIG. 6, the distance is 1.2 meters. The Lamb wave 126 is transmitted for a duration of 200 us with a carrier frequency of 417 kHz. The symmetric mode generated is S₁ with group velocity 4800 m/s.

The transmitter EMAT 122 the amplitude of the signal from the pulser is 700 mV. The power amplifier is set to 50 dB gain. The receiver EMAT 124 uses a bandpass filter with impedance matching network and LNA with 23 dB gain.

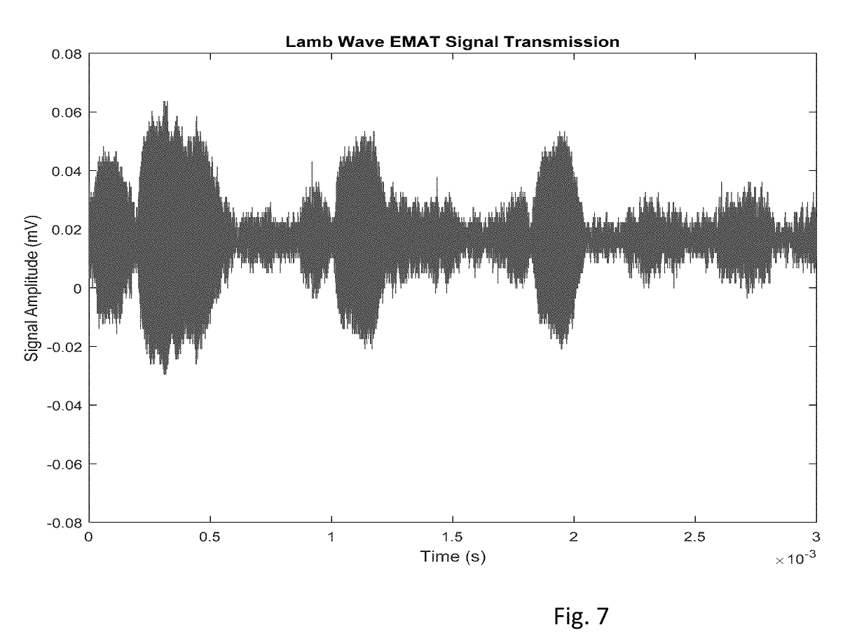

The waveform of the received signal is shown in FIG. 7. The signal quality is sufficient to decode a message, depending on the type of encoding techniques used. The embodiment shown in FIG. 6 can transmit data in various bit rates, the data transmission rate shown in FIG. 7 is approximately 5 kbps. In other embodiments, transmission rates of 100 kbps are used.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Some electro-refining processes may not produce sufficient change in molten materials for continuous sampling to be necessary. In these processes, the instant invention can be used hourly or more remote intervals to monitor the composition of molten materials in large batches.

While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all sub-ratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A system for transmitting a signal, the system comprising:
a) at least one metallic transmission medium having a proximal end and a distal end; and
b) at least a pair of transducers wherein one transducer is located at the proximal end of the transmission medium and a corresponding transducer is located at the distal end; wherein each transducer contains an interface and connection to an external signal connection capable of sending and receiving a signal;
wherein each transducer converts an external signal received by its interface to an ultrasonic signal and transmits the ultrasonic version of the external signal over the metallic transmission medium; and
wherein each transducer receives the ultrasonic version of the external signal over the metallic transmission medium and converts the ultrasonic version of the external signal and sends the signal to its interface.

2. The system for transmitting a signal of claim 1 wherein said metallic transmission medium comprises a pipe.

3. The system for transmitting a signal of claim 1 wherein said transducers comprise piezo electric transducers installed on two locations on said metallic transmission medium.

4. The system for transmitting a signal of claim 3 wherein said piezoelectric transducers generate a signal of varying power.

5. The system for transmitting a signal of claim 1 wherein said transducer interface comprises a digital network interface.

6. The system for transmitting a signal of claim 5 wherein each transducer further comprises a modulator and demodulator to convert said digital network interface signal to an ultrasonic signal.

7. The system for transmitting a signal of claim 1 wherein each said transducer comprises an integral power source.

8. The system for transmitting a signal of claim 1 wherein each said transducer external interface comprises a connection to a sensor network.

9. The system for transmitting a signal of claim 1 wherein each said transducer external interface comprises a wireless connection.

10. The system for transmitting a signal of claim 1 wherein said metallic transmission medium comprises 100 feet of pipe.

11. The system for transmitting a signal of claim 1 wherein each of said transceivers changes its mode of operation as either a sender or receiver of the ultrasonic versions of the signals pursuant to a time division scheme.

12. The system for transmitting a signal of claim 1 wherein each of said transceivers changes its mode of operation as either a sender or receiver of the ultrasonic versions of the signals depending on whether there is an external signal to transmit.
